(19) United States
(12) Patent Application Publication
(10) Pub. No.: US 2024/0041020 A1
(43) Pub. Date: Feb. 8, 2024

(54) Vermin Trapping Tool Device

(71) Applicant: Kenneth Cade, Fort Rock, OR (US)

(72) Inventor: Kenneth Cade, Fort Rock, OR (US)

(21) Appl. No.: 18/365,567

(22) Filed: Aug. 4, 2023

Related U.S. Application Data
(60) Provisional application No. 63/395,077, filed on Aug. 4, 2022.

(51) Int. Cl. A01M 23/24; A01M 17/00; B25J 15/00

(52) U.S. Cl. CPC A01M 23/245; A01M 17/00; B25J 15/0019

(57) ABSTRACT

The present invention relates to a vermin trapping tool device for identifying and excavating vermin holes. The device is comprised of a body with a first end comprised of a loop and a second end. The second end may be a plurality of shapes and can be used to puncture a ground surface to locate a vermin hole. The loop can then be used to dig out the vermin hole.

### CROSS-REFERENCE TO RELATED APPLICATION

The present application claims priority to, and the benefit of, U.S. Provisional Application No. 63/395,077, which was filed on Aug. 4, 2022, and is incorporated herein by reference in its entirety.

### FIELD OF THE INVENTION

The present invention relates generally to the field of vermin trapping. More specifically, the present invention relates to a vermin trapping tool device comprised of a body with a first end comprised of a loop and a second end. The second end may be a plurality of shapes and can be used to puncture a ground surface to locate a vermin hole. The loop can then be used to dig out the vermin hole. Accordingly, the present disclosure makes specific reference thereto. Nonetheless, it is to be appreciated that aspects of the present invention are also equally applicable to other like applications, devices, and methods of manufacture.

### BACKGROUND

Gophers and other vermin can be exceptionally problematic for hunters, gardeners, and others working in gardening and agricultural industries. Setting vermin traps can help eliminate some vermin. However, trying to locate vermin holes may be time-consuming, forcing people to spend considerable time digging to identify the hole location. In addition, the small size of vermin holes may make digging out the holes to insert traps exceptionally difficult.

Therefore, there exists a long-felt need in the art for an improved vermin tool. More specifically, there exists a long-felt need in the art for a vermin trapping tool device that allows a user to easily locate a vermin hole. There also exists a long-felt need in the art for a vermin trapping tool device that allows a user to easily dig out a vermin hole. Further, there exists a long-felt need in the art for a vermin trapping tool device that allows a user to easily insert a vermin trap into a vermin hole. Finally, there exists a long-felt need in the art for a vermin trapping tool device that allows a user to easily activate a vermin trap within a vermin hole.

The subject matter disclosed and claimed herein, in one embodiment thereof, comprises a vermin trapping tool device. The device is comprised of a body with a first end comprised of a loop and a second end. The second end may be a plurality of shapes and can be used to puncture a ground surface to locate a vermin hole. The loop can then be used to dig out the vermin hole. In addition, the loop and/or the second end can be used to place a vermin trap into a vermin hole and to set the vermin trap.

In this manner, the vermin trapping tool device of the present invention accomplishes all the foregoing objectives and provides a vermin trapping tool device that allows a user to easily locate and dig out a vermin hole. The device also allows a user to easily insert a vermin trap into a vermin hole using the loop. Finally, the device allows a user to easily activate a vermin trap within a vermin hole using the first end or the second end.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vermin trapping tool device comprised of a body with a first end comprised of a loop and a second end. The first end of the body is comprised of at least one loop that can be used to dig out a vermin hole to insert a vermin trap into the hole. The loop may also allow a user to easily grab a vermin trap using the loop as a hook-like tool. The loop may be any diameter in different embodiments. However, the diameter of the loop preferably corresponds to the width of a vermin trap that is being inserted into the hole created by the loop. In this manner, the loop diameter ensures extra space is not left around the vermin trap to allow the vermin to enter the hole around the trap without setting off the trap.

The second end of the body is used to puncture a ground surface to find an existing vermin hole. In one embodiment, the second end has a rounded tip. In another embodiment, the second end has a pointed tip for puncturing a ground surface. In a further embodiment, the second end is flat to aid in puncturing a ground surface.

The second end may be comprised of a plurality of measuring lines that may be printed or engraved on the second end. The measuring lines allow a user to ascertain the depth of the vermin hole by observing the closest measuring line about the ground surface. The lines may be symbolized by colored bands, lines, etc. The second end is also comprised of a plurality of notches that aid in puncturing a ground surface.

The device may also be comprised of a method of use. First, the second end is thrust into a ground surface to identify the location of a vermin hole. Then, the second end can be pulled out from the ground surface to remove the ground surface covering the hole. Then, the loop can be used to dig out the vermin hole such that at least one vermin trap can be inserted into the hole. Next, the tip of the second end and/or the loop may be used to position and activate the vermin trap.

Accordingly, the vermin trapping tool device of the present invention is particularly advantageous as it provides a vermin trapping tool device that allows a user to easily locate and dig out a vermin hole. The device also allows a user to easily insert a vermin trap into a vermin hole using the loop. Finally, the device allows a user to easily activate a vermin trap within a vermin hole using the first end or the second end. In this manner, the vermin trapping tool device provides a novel tool that assists a user while trapping vermin.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vermin trapping tool device of the present invention in accordance with the disclosed architecture;

FIG. 2 illustrates a side view of one potential embodiment of a vermin trapping tool device of the present invention, wherein the first end is being used to dig out a vermin hole (shown cross-sectionally) in accordance with the disclosed architecture;

FIG. 3 illustrates a side view of one potential embodiment of a vermin trapping tool device of the present invention, wherein the second end is being used to puncture a ground surface above a vermin hole (shown cross-sectionally) in accordance with the disclosed architecture;

FIG. 4 illustrates a side view of one potential embodiment of a vermin trapping tool device of the present invention, wherein the second end is being used to move/set a vermin trap inside a vermin hole (shown cross-sectionally) in accordance with the disclosed architecture; and

FIG. 5 illustrates a flowchart of a method of using one potential embodiment of a vermin trapping tool device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vermin tool. More specifically, there exists a long-felt need in the art for a vermin trapping tool device that allows a user to easily locate a vermin hole. There also exists a long-felt need in the art for a vermin trapping tool device that allows a user to easily dig out a vermin hole. Further, there exists a long-felt need in the art for a vermin trapping tool device that allows a user to easily insert a vermin trap into a vermin hole. Finally, there exists a long-felt need in the art for a vermin trapping tool device that allows a user to easily activate a vermin trap within a vermin hole.

The present invention, in one exemplary embodiment, is comprised of a vermin trapping tool device comprised of a body with a first end comprised of a loop and a second end. The first end of the body is comprised of at least one loop. The loop can be used to dig out a vermin hole to insert a vermin trap into the hole. The loop may also allow a user to easily grab a vermin trap using the loop as a hook-like tool. The diameter of the loop preferably corresponds to the width of a vermin trap that is being inserted into the hole created by the loop. In this manner, the loop diameter ensures extra space is not left around the vermin trap to allow the vermin to enter the hole around the trap without setting off the trap.

The second end of the body is used to puncture a ground surface to find an existing vermin hole. In one embodiment, the second end has a rounded tip. In another embodiment, the second end has a pointed tip for puncturing a ground surface. In a further embodiment, the second end is flat to aid in puncturing a ground surface.

The second end may be comprised of a plurality of measuring lines. The lines may be printed or engraved on the second end. The measuring lines allow a user to ascertain the depth of the vermin hole by observing the closest measuring line about the ground surface. The lines may be symbolized by colored bands, lines, etc. The second end is also comprised of a plurality of notches that aid in puncturing a ground surface.

The device may also be comprised of a method of use. First, the second end is thrust into a ground surface to identify the location of a vermin hole. Then, the second end can be pulled out from the ground surface to remove the ground surface covering the hole. Then, the loop can be used to dig out the vermin hole such that at least one vermin trap can be inserted into the hole. Next, the tip of the second end and/or the loop may be used to position and activate the vermin trap.

Accordingly, the vermin trapping tool device of the present invention is particularly advantageous as it provides a vermin trapping tool device that allows a user to easily locate and dig out a vermin hole. The device also allows a user to easily insert a vermin trap into a vermin hole using the loop. Finally, the device allows a user to easily activate a vermin trap within a vermin hole using the first end or the second end. In this manner, the vermin trapping tool device provides a novel tool that assists a user while trapping vermin.

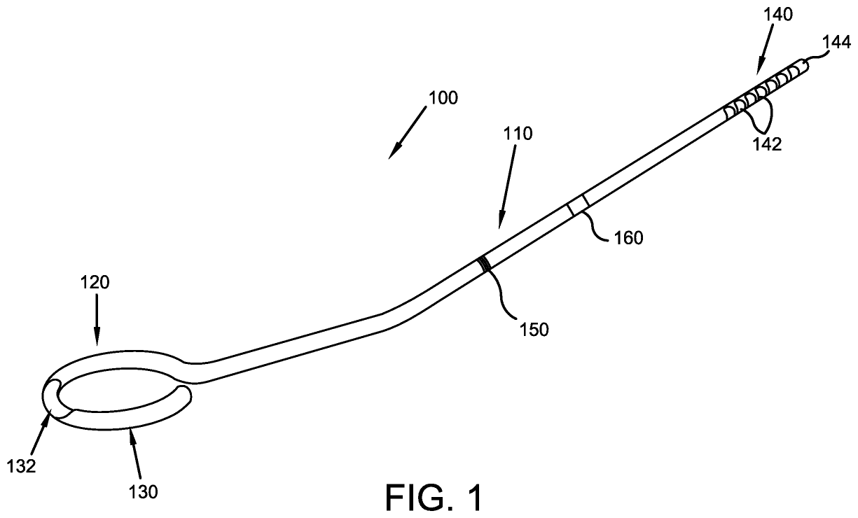

Referring initially to the drawings, FIG. 1 illustrates a perspective view of one potential embodiment of a vermin trapping tool device 100 of the present invention in accordance with the disclosed architecture. The device 100 is comprised of a body 110 with a first end 120 comprised of a loop 130 and a second end 140. The device 100 is preferably made from a rigid, corrosion-resistant metal such as, but not limited to, stainless steel or aluminum. The device 100 may also be made from a rigid plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The body 110 is preferably tubular in shape, but may be square, polygonal, etc., in different embodiments.

The body 110 may be any angle between 0 and 180 degrees. In the preferred embodiment, the body 110 forms an angle greater than 90 degrees but less than 180 degrees. This allows the body 110 to be easily inserted into a vermin hole 10.

In one embodiment, the body 110 is telescopic in length. This allows the body 110 to be collapsed for easy storage. In this embodiment, the body 110 can be locked at any length via at least one locking member 160. The member 160 may be any style of locking member known in the art such as, but not limited to, a locking button, a twisting ring lock, etc.

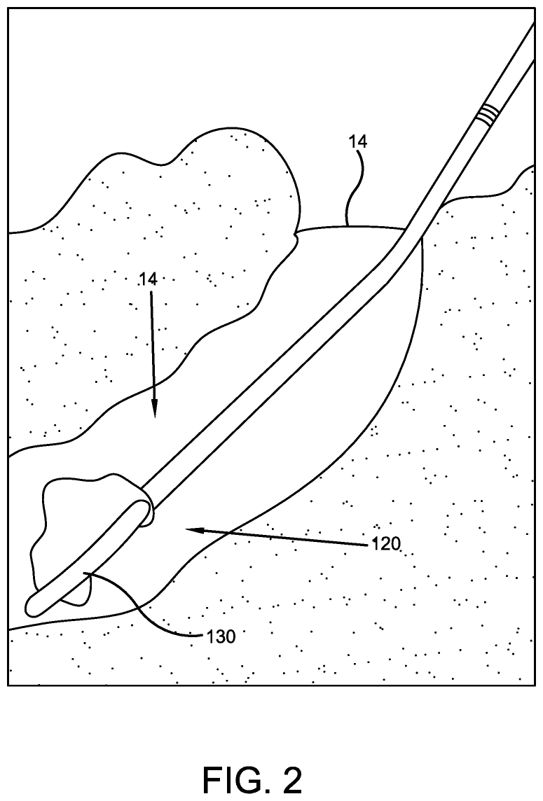

The first end 120 of the body 110 is comprised of at least one loop 130. In one embodiment, the loop 130 is a continuous loop. The loop 130 can be used to dig out a vermin hole 10 to insert a vermin trap 12 into the hole 10, as seen in FIG. 2.

In a different embodiment, the loop 130 is comprised of an open loop. The open loop 130 embodiment allows a user to easily grab a vermin trap 12 using the loop 130 as a hook-like tool.

The loop 130 may be any diameter in different embodiments. However, the diameter of the loop 130 preferably corresponds to the width of a vermin trap 12 that is being inserted into the hole 10 created by the loop 130. In this manner, the loop 130 diameter ensures extra space is not left around the vermin trap 12 to allow the vermin to enter the hole 10 around the trap 12 without setting of the trap 12.

The loop 130 is also comprised of at least one recessed area 132. The area 132 can be used to grip the loop 130 when the second end 140 of the body 110 is being used. The recessed area 132 may also improve the loop's 130 ability to remove dirt from a hole 10. The recessed area 132 can also be used to arm/disarm a vermin trap 12 by pressing on the trap 12. Further, the recessed area 132 may receive a vermin trap 23 and aid a user in placing the vermin trap 12 into a hole 10.

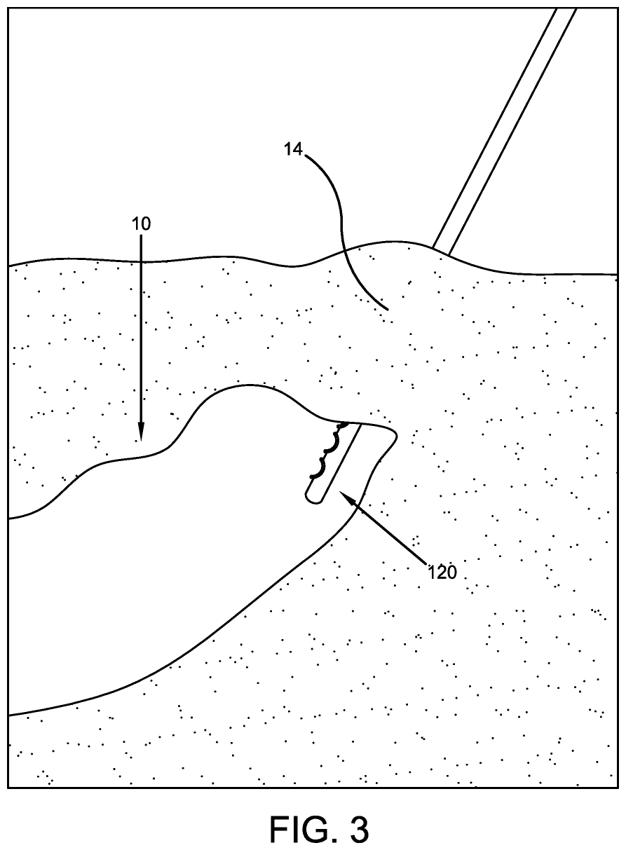

The second end 140 of the body 110 is used to puncture a ground surface 14 to find an existing vermin hole 10, as seen in FIG. 3. In one embodiment, the second end 140 has a rounded tip 144. In another embodiment, the second end 140 has a pointed tip 144 for puncturing a ground surface 14. In a further embodiment, the second end 140 is flat to aid in puncturing a ground surface 14.

The second end 140 may be comprised of a plurality of measuring lines 150. The lines may be in increments of inches, centimeters, millimeters, feet, etc. The lines 150 may be printed or engraved on the second end 140. The measuring line 150 allows a user to ascertain the depth of the vermin hole 10 by observing the closest measuring line about the ground surface 14. The lines 150 may be symbolized by colored bands, lines, etc.

The second end 140 is also comprised of a plurality of notches 142. The notches 142 aid in puncturing a ground surface 14. The notches 142 may be any shape known in the art that improves the notches' 142 ability to puncture a ground surface 14. The notches 142 also allow a user to more easily grip the second end 140 during use.

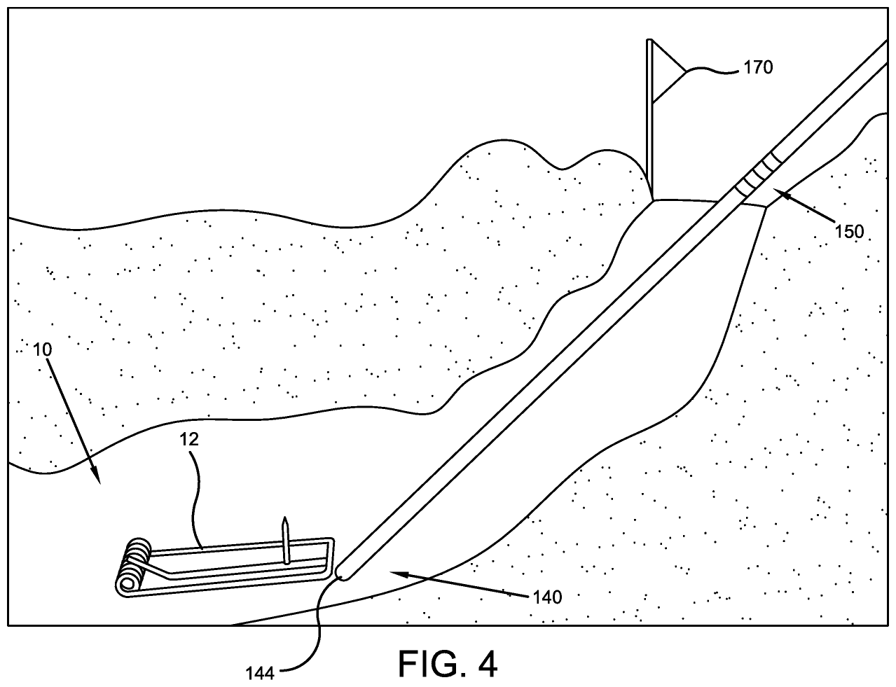

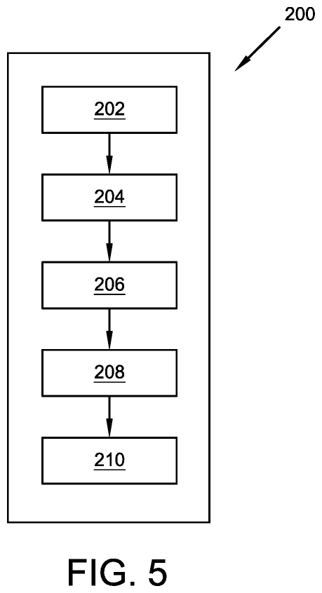

FIG. 5 illustrates a flowchart of a method of using 200 one potential embodiment of a vermin trapping tool device 100 of the present invention in accordance with the disclosed architecture. The device 100 may also be comprised of a method of use 200. First, the second end 140 is thrust into a ground surface 14 to identify the location of a vermin hole 10 [Step 202]. Then, the second end 140 can be pulled out from the ground surface 14 to remove the ground surface 14 covering the hole 10 [Step 204]. Then, the loop 130 can be used to dig out the vermin hole 10 such that at least one vermin trap 12 can be inserted into the hole 10 [Step 206]. Next, the tip 144 of the second end 140 and/or the loop 130 may be used to position and activate the vermin trap, as seen in FIG. 4 [Step 208]. At least one flag 170 can then be positioned near the hole 10 such that any individual can easily identify the hole 10 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vermin trapping tool device” and “device” are interchangeable and refer to the vermin trapping tool device 100 of the present invention.

Notwithstanding the foregoing, the vermin trapping tool device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vermin trapping tool device 100 as shown in the FIGS. are for illustrative purposes only, and that many other sizes and shapes of the vermin trapping tool device 100 are well within the scope of the present disclosure. Although the dimensions of the vermin trapping tool device 100 are important design parameters for user convenience, the vermin trapping tool device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vermin trapping tool device comprising:
a body;
a first end comprised of a loop; and
a second end comprised of a tip.

2. The vermin trapping tool device of claim 1, wherein the loop is comprised of a non-continuous loop.

3. The vermin trapping tool device of claim 1, wherein the body forms an angle greater than 90 degrees but less than 180 degrees.

4. A vermin trapping tool device comprising:
a telescopic body;
a locking member;
a first end comprised of a loop; and
a second end comprised of a tip.

5. The vermin trapping tool device of claim 4, wherein the loop is comprised of a continuous loop.

6. The vermin trapping tool device of claim 4, wherein the locking member locks the telescopic body at a length.

7. The vermin trapping tool device of claim 6, wherein the locking member is comprised of a button or a twisting ring lock.

8. The vermin trapping tool device of claim 4, wherein the loop is comprised of a recessed area.

9. The vermin trapping tool device of claim 4, wherein the vermin trapping tool device is comprised of a metal material.

10. The vermin trapping tool device of claim 4, wherein the telescopic body forms an angle greater than 0 degrees and 180 degrees.

11. A vermin trapping tool device comprising:
a body comprised of a measuring line;
a first end comprised of a loop; and
a second end comprised of a tip.

12. The vermin trapping tool device of claim 11, wherein the measuring line is in an inch increment, a centimeter increment, a millimeter increment, or a foot increment.

13. The vermin trapping tool device of claim 12, wherein the measuring line is printed on the body.

14. The vermin trapping tool device of claim 12, wherein the measuring line is engraved on the body.

15. The vermin trapping tool device of claim 11, wherein the measuring line is comprised of a colored band.

16. The vermin trapping tool device of claim 11, wherein the second end is comprised of a notch.

17. The vermin trapping tool device of claim 11, wherein the tip is comprised of a flat tip.

18. The vermin trapping tool device of claim 11, wherein the tip is comprised of a rounded tip.

19. The vermin trapping tool device of claim 11, wherein the tip is comprised of a pointed tip.

20. The vermin trapping tool device of claim 11, wherein the vermin trapping tool device is comprised of a plastic material.
